(19) United States
(12) Patent Application Publication
(10) Pub. No.: US 2004/0021133 A1
(43) Pub. Date: Feb. 5, 2004

(54) High refractive index polymerizable composition

(76) Inventors: Vidhu J. Nagpal, Murrysville, PA (US); Phillip C. Yu, Pittsburgh, PA (US); W. David Polk, Monroeville, PA (US); James P. Colton, Trafford, PA (US)

Correspondence Address: PPG Industries, Inc., Law-Intellectual Property-39SW, One PPG Place, Pittsburgh, PA, 15272, US

(21) Appl. No.: 10/602,818

(22) Filed: Jun. 25, 2003

Related U.S. Application Data
(60) Provisional application No. 60/399,994, filed on Jul. 31, 2002.

(51) Int. Cl. H01B 1/00

(52) U.S. Cl. 252/500

(57) ABSTRACT

The present invention is directed to a polymerizable composition including a polymerizable monomer component and a nanoparticle material, having a refractive index of from 1.595 to 1.695. When at least partially cured, the polymerizable composition is especially useful for ophthalmic applications.

This application claims priority to U.S. provisional patent application Serial No. 60/399,994 filed Jul. 31, 2002, which application is incorporated herein by reference in its entirety.

The present invention is directed to a polymerizable composition including a polymerizable monomer component and a nanoparticle material, having a refractive index of from 1.595 to 1.695. When at least partially cured, the polymerizable composition is especially useful for ophthalmic applications. Polymeric materials, such as plastics, have been developed as alternatives and replacements for silica-based inorganic glass in various applications such as, optical lenses, fiber optics, windows and automotive, nautical and aviation transparencies. These polymeric materials can provide advantages relative to glass, including but not limited to shatter resistance, lighter weight for a given application, ease of molding and ease of dying. Representative examples of such polymeric materials known in the art include, poly(methyl methacrylate), polycarbonate and poly(diethylene glycol bis(allylcarbonate).

In general, the refractive index of a polymeric material is lower than that of high index glass. For example, the refractive index of poly(diethylene glycol bis(allylcarbonate)) is about 1.50, compared to that of high index glass which can range from about 1.60 to 1.80. When fabricating ophthalmic lenses to correct a given degree of visual defect, such as correction for myopia, the use of a polymeric material having a lower refractive index will require a thicker lens relative to a material having a higher refractive index, such as high index glass. If the degree of correction required is substantial, as in the case of severe myopia, the thickness of a lens fabricated from a low index polymeric material can negate any benefit of reduction in weight relative to an equivalent degree of correction obtained from a higher refractive index lens, such as a high index glass lens. Furthermore, thicker optical lenses are generally not aesthetically desirable.

The preparation of a polymeric material having a refractive index greater than 1.50 from monomers containing halogens and/or sulfur atoms is known in the art. The materials from which lenses, and in particular optical lenses, are fabricated can be categorized by refractive index. In general, “low refractive index” can include indices of refraction of from less than 1.50 through 1.53; “middle refractive index” can include indices of refraction of from 1.54 through 1.57; “high refractive index” can include indices of refraction of from 1.58 through 1.66; and “ultra high refractive index” can include indices of refraction of 1.67 and greater. In general, polymeric materials prepared from the polymerization of monomers containing aromatic rings have high refractive indices. However, articles such as optical lenses, prepared from high index polymeric materials, generally have low Abbe numbers (also known as nu-values). A low Abbe number is typically indicative of an increasing level of chromatic dispersion, which can be manifested as an optical distortion at or near the rim of the lens. A “low Abbe number” can include Abbe numbers of less than 25.

It is accordingly desirable to identify new polymerizable organic materials which can be used to prepare transparent polymerizates that possess high and ultra high refractive indices. The usefulness and applications of said polymerizates may vary widely. In particular, a transparent polymerizate may be especially useful in an optical lens. The transparent polymerizate may possess a high Abbe number. A “high Abbe number” can include Abbe numbers of at least 25, or at least 28, or at least 33 or at least 35. It may be desirable that the transparent polymerizate possess a high refractive index or an ultra high refractive index in combination with a high Abbe number. It is further desirable that these polymeric materials also possess physical properties, and in particular thermal properties, that are at least equivalent to and preferably better than those of lower index polymeric materials.

More recently, polymeric material having a combination of high refractive index and high Abbe number, have been prepared from monomers containing sulfur atoms. While possessing a desirable combination of high refractive index and Abbe number, such sulfur atom containing polymeric materials often have physical properties, such as heat and impact resistance, that are in some instances less than desirable. For example, the impact resistance of an optical lens is a particularly important safety-related physical property, and improvements in impact resistance of optical lenses prepared from sulfur-containing polymeric materials are accordingly desirable. It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

### SUMMARY OF THE INVENTION

The present invention is directed to a polymerizable composition comprising a polymerizable monomer component and a nanoparticle material, said polymerizable composition when at least partially cured having a refractive index of from 1.595 to 1.695.

### DETAILED DESCRIPTION OF THE INVENTION

The polymerizable composition of the present invention includes a polymerizable monomer component and a nanoparticle material. The polymerizable monomer component can be chosen from a wide variety of monomers known to one having ordinary skill in the art. The monomer can be chosen such that the polymerizable composition when at least partially cured has a refractive index of from 1.595 to 1.695. In a non-limiting embodiment, the monomer can be chosen such that when at least partially cured, a transparent article, such as but not limited to a lens for ophthalmic and optical applications, can be produced.

Furthermore, the polymerizable monomer component can be chosen such that polymerization of the polymerizable composition of the present invention can take place by any means well known to those skilled in the art, for example, by free radial initiation, vinyl addition polymerization, a condensation mechanism, or combinations thereof. In general, the particular means of polymerization employed will depend upon the monomer(s) selected for use in the invention. As one skilled in the art will appreciate, for example, unsaturated monomers or prepolymers can polymerize by free radical initiation, or vinyl addition polymerization; monomers or prepolymers possessing groups capable of condensation, for example, hydroxyl and isocyanate or isocyanate and amine, can polymerize by a condensation mechanism.

A variety of monomers suitable for use in the present invention are exemplified below. In a non-limiting embodiment, the polymerizable monomer component of the present invention can be an ethylenically unsaturated monomer. As used herein and the claims, “ethylenically unsaturated” includes allytic unsaturation, alpha-beta ethylenic unsaturation, and vinyl unsaturation. The ethylenically unsaturated monomer can be a monoethylenically unsaturated monomer or a polyethylenically unsaturated monomer. As used herein and the claims, the term “monoethylenically unsaturated monomer” refers to a monomer having only a single ethylenically unsaturated group, and the term “polyethylenically unsaturated monomer” refers to a monomer having more than one ethylenically unsaturated group. The ethylenically unsaturated monomer can be aliphatic, cycloaliphatic, aromatic, or combinations thereof Suitable ethylenically unsaturated monomers for use in the present invention can include at least one monomer having ethylenically unsaturated group(s) such as vinyl, allyl, substituted allyl, (meth)acryloyl and combinations thereof As used herein and the claims, the term “(meth)acryloyl” refers to acryloyl groups, methacryloyl groups and combinations of acryloyl and methacryloyl groups.

In a non-limiting embodiment, the ethylenically unsaturated monomer can be selected from aromatic monomers having at least two vinyl groups, such as but not limited to 1,2-divinyl benzene, 1,3-divinyl benzene, 1,4-divinyl benzene and mixtures of structural isomers of divinyl benzene; diisopropenyl benzene, for example, 1,2-diisopropenyl benzene, 1,3-diisopropenyl benzene, 1,4-diisopropenyl benzene and mixtures of structural isomers of diisopropenyl benzene; trivinyl benzene, for example, 1,2,4-triethenyl benzene, 1,3,5-triethenyl benzene and mixtures of structural isomers of trivinyl benzene; divinyl naphthalene, for example, 2,6-diethenyl naphthalene, 1,7-diethenyl naphthalene, 1,4-diethenyl naphthalene and mixtures of structural isomers of divinyl naphthalene; halogen-substituted derivatives of divinyl benzene, diisopropenyl benzene, trivinyl benzene and divinyl naphthalene, for example, 2-chlorol,4-diethenyl benzene; and mixtures of thereof.

In another non-limiting embodiment, the ethylenically unsaturated monomer can be selected from monoethylenically unsaturated monomers such as but not limited to acrylic acid, methacrylic acid, esters of acrylic acid such as but not limited to methyl acrylate and 2-hydroxyethyl acrylate, esters of methacrylic acid, such as but not limited to methyl methacrylate, 2-hydroxyethyl methacrylate and phenoxyethyl methacrylate, allyl esters, such as but not limited to allyl benzoate; allyl carbonates, such as but not limited to phenyl allyl carbonate; vinyl esters such as but not limited to vinyl acetate; styrene; vinyl chloride; and anhydrides having a single ethylenically unsaturated group, such as but not limited to maleic anhydride, 1-cyclopentene-1,2-dicarboxylic anhydride and itaconic anhydride.

In a further non-limiting embodiment, the ethylenically unsaturated monomer can include polyethylenically unsaturated monomer such as but not limited to allyl methacrylate, ethyleneglycol dimethacrylate, triallyl cyanurate, pentaerythritol tetraacrylate, di-pentaerythritoltriacrylate, di-pentaerythritolpentaacrylate, ethoxylated trimethylolpropane triacrylate having up to 20 ethoxy units, ethoxylated trimethylolpropane trimethacrylate having up to 20 ethoxy unit, and mixtures thereof.

In a non-limiting embodiment, the polymerizable monomer component can include a polyol(allyl carbonate) monomer. As used herein and the claims, the term “polyol(allyl carbonate) monomer” or like names, such as, diethylene glycol bis(allyl carbonate), means the named monomers or prepolymers thereof and any related monomer or oligomer species contained therein. Suitable polyol(allyl carbonate) monomers can include allyl 2.5 carbonates of linear or branched aliphatic or cycloaliphatic, or aromatic polyols such as but not limited to aliphatic glycol bis(allyl carbonate) compounds and alkylidene bisphenol bis(allyl carbonate) compounds. These monomers can be described as unsaturated polycarbonates of polyols such as but not limited to glycols.

Non-limiting examples of polyol(allyl carbonate) monomers can include but are not limited to ethylene glycol bis(2-chloroallyl carbonate), ethylene glycol bis(allyl carbonate), diethylene glycol bis(2-methylallyl carbonate), diethylene glycol bis(allyl carbonate), triethylene glycol bis(allyl carbonate), propylene glycol bis(2-ethylallyl carbonate), 1,3-propanediol bis(allyl carbonate), 1,3-butanediol bis(allyl carbonate), 1,4 butanediol bis(2-bromoallyl carbonate), dipropylene glycol bis(allyl carbonate), trimethylene glycol bis(2-ethylallyl carbonate), pentamethylene glycol bis(allyl carbonate), 4,4′-isopropylidenediphenol bis(allyl carbonate), and 4,4′-isopropylidenebiscyclohexanol bis(allyl carbonate). In a further non-limiting embodiment, the polyol(allyl carbonate) monomer can be diethylene glycol bis(allyl carbonate).

The polyol(allyl carbonate) monomers can be prepared by various methods known in the art. In a non-limiting embodiment, the polyol(allyl carbonate) monomer can be prepared as described in U.S. Pat. No. 4,637,698 at column 3, line 33 through column 5, line 61, which is incorporated herein by reference.

In a non-limiting embodiment, combinations of monomers having different ethylenically unsaturated groups can be used, such as but not limited to combinations of vinyl functional, (meth)acryloyl functional and allyl functional monomers.

In another non-limiting embodiment, the polymerizable monomer component of the present invention can be a thiol monomer. As used herein and the claims, the terms “thiol,” “thiol group,” “mercapto” or “mercapto group” refer to an —SH group which is capable of forming a thiourethane linkage, (i.e., —NH—C(O)—S-) with an isocyanate group, or a dithioruethane linkage (i.e., —NH—C(S)—S—) with an isothiocyanate group. In a further non-limiting embodiment, the thiol monomer can be selected from polythiol monomers having at least two thiol groups. The polythiol monomer can be selected from aliphatic polythiols, cycloaliphatic polythiols, aromatic polythiols and combinations thereof The polythiol monomer can contain linkages selected from ether linkages (—O—), sulfide linkages (—S—), polysulfide linkages (—Sₓ—, wherein x is at least 2, e.g., from 2 to 4) and combinations of such linkages.

Non-limiting examples of suitable polythiol monomers can include but are not limited to 2,5-dimercaptomethyl-1,4-dithiane, 2,2′-thiodiethanethiol, pentaerythritol tetrakis(3-mercaptopropionate), pentaerythritol tetrakis(2-mercaptoacetate), tetrakis(7mercapto-2,5-dithiaheptyl)methane, trimethylolpropane tris(3-mercaptopropionate), trimethylolpropane tris(2-mercaptoacetate), 4-mercaptomethyl-3,6-dithia-1,8octanedithiol, 4-tert-butyl-1,2-benzenedithiol, 4,4′-thiodibenzenethiol, benzenedithiol, ethylene glycol di(2-mercaptoacetate), ethylene glycol di(3-mercaptopropionate), poly(ethylene glycol) di(2-mercaptoacetate) and poly(ethylene glycol) di(3mercaptopropionate), and mixtures thereof.

In another non-limiting embodiment of the present invention, the polymerizable monomer component can be an aromatic monomer having at least two vinyl groups. Non-limiting examples of such aromatic monomers can include divinyl benzenes, such as but not limited to 1,2-divinyl benzene, 1,3-divinyl benzene, 1,4-divinyl benzene and mixtures of structural isomers of divinyl benzene; diisopropenyl benzene, such as but not limited to 1,2-diisopropenyl benzene, 1,3-diisopropenyl benzene, 1,4-diisopropenyl benzene and mixtures of structural isomers of diisopropenyl benzene; trivinyl benzene, such as but not limited to 1,2,4-triethenyl benzene, 1,3,5-triethenyl benzene and mixtures of structural isomers of trivinyl benzene; divinyl naphthalene, such as but not limited to 2,6-diethenyl naphthalene, 1,7-diethenyl naphthalene, 1,4-diethenyl naphthalene and mixtures of structural isomers of divinyl naphthalene; halogen-substituted derivatives of divinyl benzene, diisopropenyl benzene, trivinyl benzene and divinyl naphthalene, such as but not limited to 2-chloro-1,4-diethenyl benzene; and mixtures of such aromatic monomers. In a further non-limiting embodiment, the aromatic monomer having at least two vinyl groups can be divinyl benzene.

In a non-limiting embodiment, the polymerizable monomer component of the present invention can be a polycyanate monomer selected from polyisocyanates having at least two isocyanate groups, polyisothiocyanates having at least two isothiocyanate groups and polycyanates having both isocyanate and isothiocyanate groups. Suitable polycyanates can include but are not limited to aliphatic polyisocyanates and polyisothiocyanates; ethylenically unsaturated polyisocyanates and polyisothiocyanates; alicyclic polyisocyanates and polyisothiocyanates; aromatic polyisocyanates and polyisothiocyanates wherein the isocyanate groups are not bonded directly to the aromatic ring; aromatic polyisocyanates and polyisothiocyanates wherein the isocyanate groups are bonded directly to the aromatic ring; aliphatic polyisocyanates and polyisothiocyanates containing sulfide linkages; aromatic polyisocyanates and polyisothiocyanates containing sulfide or disulfide linkages; aromatic polyisocyanates and polyisothiocyanates containing sulfone linkages; sulfonic ester-type polyisocyanates and polyisothiocyanates; aromatic sulfonic amide-type polyisocyanates and polyisothiocyanates; sulfur-containing heterocyclic polyisocyanates and polyisothiocyanates; halogenated, alkylated, alkoxylated, nitrated, carbodiimide modified, urea modified and biuret modified derivatives of polyisocyanates and polyisothiocyanates belonging to these classes; and dimerized and trimerized products of polycyanates belonging to these classes.

In a further non-limiting embodiment, the polycyanate monomer can include polycyanates having backbone linkages selected from urethane linkages, thiourethane linkages, thiocarbamate linkages, dithiourethane linkages, and combinations thereof.

Non-limiting examples of aliphatic polyisocyanates can include but are not limited to ethylene diisocyanate, trimethylene diisocyanate, tetramethylene diisocyanate, hexamethylene diisocyanate, octamethylene diisocyanate, nonamethylene diisocyanate, 2,2′-dimethylpentane diisocyanate, 2,2,4-trimethylhexane diisocyanate, decamethylene diisocyanate, 2,4,4,-trimethylhexamethylene diisocyanate, 1,6,11-undecanetriisocyanate, 1,3,6-hexamethylene triisocyanate, 1,8-diisocyanato-4-(isocyanatomethyl)octane, 2,5,7trimethyl-1,8-diisocyanato-5-(isocyanatomethyl)octane, bis(isocyanatoethyl)-carbonate, bis(isocyanatoethyl)ether, 2-isocyanatopropyl-2,6-diisocyanatohexanoate, lysinediisocyanate methyl ester and lysinetriisocyanate methyl ester.

Non-limiting examples of aliphatic polyisothiocyanates can include but are not limited 1,2-diisothiocyanatoethane, 1,3-diisothiocyanatopropane, 1,4diisothiocyanatobutane and 1,6-diisothiocyanatohexane.

Non-limiting examples of ethylenically unsaturated polyisocyanates can include but are not limited to butene diisocyanate and 1,3-butadiene-1,4-diisocyanate.

Non-limiting examples of alicyclic polyisocyanates can include but are not limited to isophorone diisocyanate, cyclohexane diisocyanate, methylcyclohexane diisocyanate, bis(isocyanatomethyl)cyclohexane, bis(isocyanatocyclohexyl)methane, bis(isocyanatocyclohexyl)-2,2-propane, bis(isocyanatocyclohexyl)-1,2-ethane, 2isocyanatomethyl-3-(3-isocyanatopropyl)-5-isocyanatomethyl-bicyclo[2.2.1]-heptane, 2isocyanatomethyl-3-(3-isocyanatopropyl)-6-isocyanatomethyl-bicyclo[2.2.1]-heptane, 2isocyanatomethyl-2-(3-isocyanatopropyl)-5-isocyanatomethyl-bicyclo[2.2.1 ]-heptane, 2isocyanatomethyl-2-(3-isocyanatopropyl)-6-isocyanatomethyl-bicyclo[2.2.1]-heptane, 2isocyanatomethyl-3-(3-isocyanatopropyl)-6-(2-isocyanatoethyl)-bicyclo[2.2.1]-heptane, 2isocyanatomethyl-2-(3-isocyanatopropyl)-5-(2-isocyanatoethyl)-bicyclo[2.2.1]-heptane and 2-isocyanatomethyl-2-(3-isocyanatopropyl)-6-(2-isocyanatoethyl)-bicyclo[2.2.1]heptane.

Non-limiting examples of alicyclic polyisothiocyanates can include but are not limited to isophorone diisothiocyanate, cyclohexane diisothiocyanate, methylcyclohexane diisothiocyanate, and mixtures thereof.

Non-limiting examples of aromatic polyisocyanates wherein the isocyanate groups are not bonded directly to the aromatic ring can include but are not limited to α,α′-xylene diisocyanate, bis(isocyanatoethyl)benzene, α,α,α′,α′-tetramethylxylene diisocyanate, 1,3bis(1-isocyanato-1-methylethyl)benzene, bis(isocyanatobutyl)benzene, bis(isocyanatomethyl)naphthalene, bis(isocyanatomethyl)diphenyl ether, bis(isocyanatoethyl)phthalate, mesitylene triisocyanate, 2,5-di(isocyanatomethyl)furan, and mixtures thereof.

Non-limiting examples of aromatic polyisothiocyanates wherein the isothiocyanate groups are not bonded directly to the aromatic ring can include but are not limited to α,α′-xylene diisothiocyanate, bis(isothiocyanatoethyl)benzene, α,α,α′,α′-tetramethylxylene diisothiocyanate, and mixtures thereof. Non-limiting examples of aromatic polyisocyanates wherein the isocyanate groups are bonded directly to the aromatic ring can include but are not limited to benzene diisocyanate, phenylene diisocyanate, ethylphenylene diisocyanate, isopropylphenylene diisocyanate, dimethylphenylene diisocyanate, diethylphenylene diisocyanate, diisopropylphenylene diisocyanate, trimethylbenzene triisocyanate, benzene triisocyanate, naphthalene diisocyanate, methylnaphthalene diisocyanate, biphenyl diisocyanate, orthotoluidine diisocyanate, ortho-tolylidine diisocyanate, ortho-tolylene diisocyanate, 4,4′-diphenylmethane diisocyanate, bis(3-methyl-4-isocyanatophenyl)methane, bis(isocyanatophenyl)ethylene, 3,3′-dimethoxy-biphenyl-4,4′-diisocyanate, triphenylmethane triisocyanate, polymeric 4,4′-diphenylmethane diisocyanate, naphthalene triisocyanate, diphenylmethane-2,4,4′-triisocyanate, 4methyldiphenylmethane-3,5,2′,4′,6′-pentaisocyanate, diphenylether diisocyanate, bis(isocyanatophenylether)ethyleneglycol, bis(isocyanatophenylether)-1,3propyleneglycol, benzophenone diisocyanate, carbazole diisocyanate, ethylcarbazole diisocyanate and dichlorocarbazole diisocyanate.

Non-limiting examples of aromatic polyisothiocyanates wherein the isothiocyanate groups are bonded directly to the aromatic ring can include but are not limited to phenylene diisothiocyanate, 1,2-diisothiocyanatobenzene, 1,3-diisothiocyanatobenzene, 1,4-diisothiocyanatobenzene, 2,4-diisothiocyanatotoluene, 2,5-diisothiocyanato-m-xylene, 4,4′-diisothiocyanato-1,1′-biphenyl, 1,1′-methylenebis(4-isothiocyanatobenzene), 1,1′-methylenebis(4-isothiocyanato-2-methylbenzene), 1,1,-methylenebis(4-isothiocyanato-3methylbenzene), 1,1′-(1,2-ethane-diyl)bis(4-isothiocyanatobenzene), 4,4′-diisothiocyanatobenzophenenone, 4,4′-diisothiocyanato-3,3′-dimethylbenzophenone, benzanilide-3,4′-diisothiocyanate, diphenylether-4,4′-diisothiocyanate and diphenylamine-4,4′-diisothiocyanate.

Non-limiting examples of aliphatic polyisocyanates containing sulfide linkages can include but are not limited to thiodiethyl diisocyanate, thiodipropyl diisocyanate, dithiodihexyl diisocyanate, dimethylsulfone diisocyanate, dithiodimethyl diisocyanate, dithiodiethyl diisocyanate, dithiodipropyl diisocyanate and dicyclohexylsulfide-4,4′-diisocyanate.

Non-limiting examples of aliphatic polyisothiocyanates containing sulfide linkages can include but are not limited to thiodiethyl diisothiocyante, thiodipropyl diisothiocyanate, thiobis(3-isothiocyanatopropane), and mixtures thereof.

Non-limiting examples of aromatic polyisocyanates containing sulfide or disulfide linkages include, but are not limited to, diphenylsulfide-2,4′-diisocyanate, diphenylsulfide-4,4′-diisocyanate, 3,3′-dimethoxy-4,4′-diisocyanatodibenzyl thioether, bis(4-isocyanatomethylbenzene)-sulfide, diphenyldisulfide-4,4′-diisocyanate, 2,2′-dimethyldiphenyldisulfide-5,5′-diisocyanate, 3,3′-dimethyldiphenyldisulfide-5,5′-diisocyanate, 3,3′-dimethyldiphenyldisulfide-6,6′-diisocyanate, 4,4′-dimethyldiphenyldisulfide-5,5′-diisocyanate, 3,3′-dimethoxydiphenyldisulfide-4,4′-diisocyanate and 4,4′-dimethoxydiphenyldisulfide-3,3′-diisocyanate. Non-limiting examples of aromatic polyisocyanates containing sulfone linkages can include but are not limited to diphenylsulfone-4,4′-diisocyanate, diphenylsulfone-3,3′-diisocyanate, benzidinesulfone-4,4′-diisocyanate, diphenylmethanesulfone-4,4′-diisocyanate, 4-methyldiphenylmethanesulfone-2,4′-diisocyanate, 4,4′-dimethoxydiphenylsulfone-3,3′-diisocyanate, 3,3′-dimethoxy-4,4′-diisocyanatodibenzylsulfone, 4,4′-dimethyldiphenylsulfone-3,3′-diisocyanate, 4,4′-di-tert-butyl-diphenylsulfone-3,3′-diisocyanate and 4,4′-dichlorodiphenylsulfone-3,3′-diisocyanate.

Non-limiting examples of aromatic sulfonic amide-type polyisocyanates can include but are not limited to 4-methyl-3-isocyanato-benzene-sulfonylanilide-3′-methyl-4′-isocyanate, dibenzenesulfonyl-ethylenediamine-4,4′-diisocyanate, 4,4′-methoxybenzenesulfonyl-ethylenediamine-3,3′-diisocyanate and 4-methyl-3-isocyanatobenzene-sulfonylanilide-4-ethyl-3′-isocyanate.

Non-limiting examples of aromatic polyisothiocyanates containing sulfur atoms in addition to those of the isothiocyanate groups can include but are not limited to 1isothiocyanato-4-[(2-isothiocyanato)sulfonyl]benzene, thiobis(4-isothiocyanatobenzene), sulfonylbis(4-isothiocyanatobenzene), sulfinylbis(4-isothiocyanatobenzene), dithiobis(4isothiocyanatobenzene), 4-isothiocyanato-1-[(4-isothiocyanatophenyl)-sulfonyl]-2methoxybenzene, 4-methyl-3-isothicyanatobenzene-sulfonyl-4′-isothiocyanate phenyl ester and 4-methyl-3-isothiocyanatobenzene-sulfonylanilide-3′-methyl-4′-isothiocyanate.

In another non-limiting embodiment, the polycyanate monomer can include heterocyclic polyisothiocyanates, such as but not limited to 2,4,6-triisothicyanato-1,3,5triazine and thiophene-2,5-diisothiocyanate; carbonyl polyisothiocyanates such as but not limited to hexane-dioyl diisothiocyanate, nonaedioyl diisothiocyanate, carbonic diisothiocyanate, 1,3-benzenedicarbonyl diisothiocyante, 1,4-benzenedicarbonyl diisothiocyanate and (2,2′-bipyridine)-4,4′-dicarbonyl diisothiocyanate; and mixtures thereof.

In another non-limiting embodiment, the polycyanate monomer can be selected from polycyanate monomers having both isocyanate and isothiocyanate groups such as but not limited to aliphatic, alicyclic, aromatic, heterocyclic, or sulfur atoms in addition to those of the isothiocyanate groups. Non-limiting examples of such compounds can include but are not limited to 1-isocyanato-3-isothiocyanatopropane, 1-isocanato-5isothiocyanatopentane, 1-isocyanato-6-isothiocyanatohexane, isocyanatocarbonyl isothiocyanate, 1-isocyanato-4-isothiocyanatocyclohexane, 1-isocyanato-4isothiocyanatobenzene, 4-methyl-3-isocyanato-1-isothiocyanatobenzene, 2-isocyanato-4,6-diisothiocyanato-1,3,5-triazine, 4-isocyanato-4′-isothiocyanato-diphenyl sulfide and 2isocyanato-2′-isothiocyanatodiethyl disulfide.

In a non-limiting embodiment, the polymerizable monomer component can include a prepolymer. Suitable prepolymers and methods of their preparation are known in the art, and are numerous and varied. As is appreciated by one having ordinary skill in the art, prepolymers can polymerize by free radical initiation, or vinyl addition polymerization; monomers or prepolymers possessing groups capable of condensation, for example, hydroxyl and isocyanate or isocyanate and amine, can polymerize by a condensation mechanism. Suitable prepolymers for use in the present invention can have molecular weights that vary within a wide range. In a non-limiting embodiment, a polycyanate functional prepolymer can have a number average molecular weight (Mn) of from 500 to 15000, or from 500 to 5000, as determined by gel permeation chromatography (GPC) using polystyrene standards.

In a non-limiting embodiment, a prepolymer can be the reaction product of a polycyanate monomer and one or more active hydrogen materials. The polycyanate monomer can be selected from those previously recited herein. The active hydrogen material can include but is not limited to polyols, polythiols and materials having both hydroxyl and thiol groups.

Non-limiting examples of suitable polyols for use in the present invention can include straight or branched chain alkane polyols, such as but not limited to 1,2ethanediol, 1,3-propanediol, 1,2-propanediol, 1,4-butanediol, 1,3-butanediol, glycerol, neopentyl glycol, trimethylolethane, trimethylolpropane, di-trimethylolpropane, erythritol, pentaerythritol and di-pentaerythritol; polyalkylene glycols, such as but not limited to diethylene glycol, dipropylene glycol and higher polyalkylene glycols such as but not limited to polyethylene glycols having number average molecular weights of, for example, from 200 to 2000 grams/mole; cyclic alkane polyols, such as but not limited to cyclopentanediol, cyclohexanediol, cyclohexanetriol, cyclohexanedimethanol, hydroxypropylcyclohexanol and cyclohexanediethanol; aromatic polyols, such as but not limited to dihydroxybenzene, benzenetriol, hydroxybenzyl alcohol and dihydroxytoluene; bisphenols, such as but not limited to 4,4′-isopropylidenediphenol, 4,4′-oxybisphenol, 4,4′-dihydroxybenzophenone, 4,4′-thiobisphenol, phenolphthlalein, bis(4hydroxyphenyl)methane, 4,4′-(1,2-ethenediyl)bisphenol and 4,4′-sulfonylbisphenol; halogenated bisphenols, such as but not limited to 4,4′-isopropylidenebis(2,6dibromophenol), 4,4′-isopropylidenebis(2,6-dichlorophenol) and 4,4′-isopropylidenebis(2,3,5,6-tetrachlorophenol); alkoxylated bisphenols, such as but not limited to alkoxylated 4,4′-isopropylidenediphenol having from 1 to 70 alkoxy groups, for example, ethoxy, propoxy, α-butoxy and β-butoxy groups; biscyclohexanols, which can be prepared by hydrogenating the corresponding bisphenols, such as but not limited to 4,4′-isopropylidene-biscyclohexanol, 4,4′-oxybiscyclohexanol, 4,4′-thiobiscyclohexanol and bis(4-hydroxycyclohexanol)methane; polyurethane polyols; polyester polyols; polyether polyols; poly vinyl alcohols; polymers containing hydroxy functional acrylates; polymers containing hydroxy functional methacrylates; polymers containing allyl alcohols; and mixtures thereof

In a non-limiting embodiment, the polyol for use in the present invention can be a polyether polyol, polyester polyol, polycaprolactone polyol, polycarbonate polyol, and mixtures thereof

In further non-limiting embodiments of the present invention, the polyol can have a number average molecular weight (Mn) of from 200 to 2000, or from 500 to 1500, or from 800 to 1200.

In another non-limiting embodiment, the polyol can be selected from multifunctional polyols, such as but not limited to trimethylopropane, ethoxylated trimethylolpropane, pentaerythritol, and mixtures thereof.

The polythiols for use in the present invention, having at least two thiol groups, can be selected from aliphatic polythiols, cycloaliphatic polythiols, aromatic polythiols, polymeric polythiols and mixtures thereof In a non-limiting embodiment, the polythiol can include linkages selected from ether linkages (—O—), sulfide linkages (—S—), polysulfide linkages (—Sx—, wherein x is at least 2, or from 2 to 4) and combinations of such linkages.

Non-limiting examples of suitable polythiols can include but are not limited to 2,5dimercaptomethyl-1,4-dithiane, 2,2′-thiodiethanethiol, pentaerythritol tetrakis(3mercaptopropionate), pentaerythritol tetrakis(2-mercaptoacetate), trimethylolpropane tris(3-mercaptopropionate), trimethylolpropane tris(2-mercaptoacetate), 4-mercaptomethyl-3,6-dithia-1,8-octanedithiol, 4-tert-butyl-1,2-benzenedithiol, 4,4′-thiodibenzenethiol, benzenedithiol, ethylene glycol di(2-mercaptoacetate), ethylene glycol di(3-mercaptopropionate), poly(ethylene glycol) di(2-mercaptoacetate), poly(ethylene glycol) di(3-mercaptopropionate), and mixtures thereof.

In another non-limiting embodiment, the polythiol can include a polythiol oligomer having disulfide linkages. The polythiol oligomer can be prepared by a variety of methods known to one having ordinary skill in the art. In a non-limiting embodiment, the polythiol oligomer can be prepared by reacting a polythiol monomer having at least two thiol groups and sulfur in the presence of a basic catalyst. In a further non-limiting embodiment, the molar equivalent ratio of polythiol monomer to sulfur can be from 2:1 to 21:20.

In another non-limiting embodiment, the active hydrogen material can have both hydroxyl and thiol groups. Such suitable materials for use in the present invention can include but are not limited to 2-mercaptoethanol, 3-mercapto-1,2-propanediol, glycerin bis(2-mercaptoacetate), glycerin bis(3-mercaptopropionate), 1-hydroxy-4mercaptocyclohexane, 2,4-dimercaptophenol, 2-mercaptohydroquinone, 4mercaptophenol, 1,3-dimercapto-2-propanol, 2,3-dimercapto-1-propanol, 1,2-dimercapto-1,3-butanediol, trimethylolpropane bis(2-mercaptoacetate), trimethylolpropane bis(310 mercaptopropionate), pentaerythritol mono(2-mercaptoacetate), pentaerythritol bis(2mercaptoacetate), pentaerythritol tris(2-mercaptoacetate), pentaerythritol mono(3mercaptopropionate), pentaerythritol bis(3-mercaptopropionate), pentaerythritol tris(3mercaptopropionate), hydroxymethyl-tris(mercaptoethylthiomethyl)methane, 1hydroxyethylthio-3-mercaptoethylthiobenzene, 4-hydroxy-4′-mercaptodiphenylsulfone, dihydroxyethyl sulfide mono(3-mercaptopropionate and hydroxyethylthiomethyltris(mercaptoethylthio)methane, and mixtures thereof.

In a further non-limiting embodiment, the active hydrogen material can include polyurethane prepolymer having two or more hydroxy groups. Suitable polyurethane prepolymers for use in the present invention are known in the art, and are numerous and varied. In a non-limiting embodiment, a hydroxy functional polyurethane prepolymer can be prepared by reacting at least one of the polyols previously recited herein with at least one of the polycyanates previously recited herein. In general, the ratio of molar equivalents of hydroxy groups to cyanate groups can be selected such that the resultant hydroxy functional polyurethane prepolymer has essentially no free cyanate groups.

In a further non-limiting embodiment, the active hydrogen material for use in the present invention can include polyesters such as but not limited to polycaprolactones and polyesters based on esterification of dicarboxylic acids of four to ten carbon atoms. In a non-limiting embodiment, a polycaprolactone can be prepared by condensing caprolactone in the presence of a difunctional active hydrogen compound such as water or a low molecular weight glycol. Non-limiting examples of low molecular weight glycols can include but are not limited to ethylene glycol, propylene glycol, diethylene glycol, 1,4butanediol, 1,6-hexanediol and 1,10-decanediol. In a non-limiting embodiment, a dicarboxylic acid can be esterified in the presence of a low molecular weight glycol having from two to ten carbon atoms. Non-limiting examples of such dicarboxylic acids include but are not limited to adipic, succinic and sebacic acids.

In another embodiment, the active hydrogen material can include polyether glycols and polyester glycols having a weight average molecular weight of at least 200, or at least 300, or at least 750, to 1,200, or to 1,500 or to 2,500. Non-limiting examples can include but are not limited to polytetramethylene ether glycols having a weight average molecular weight of from 300 to 1000.

In a non-limiting embodiment, the polymerizable monomer component of the present invention can be substantially aliphatic. The term “substantially aliphatic” as used herein and the claims means that less than 30% of the polymerizable monomer component is non-aliphatic.

In a non-limiting embodiment, the polymerizable monomer component of the present invention can include an epoxide monomer, epoxide prepolymer and combinations thereof. Suitable epoxide monomers and prepolymers can be selected from such numerous and varied ones that are known in the art. Non-limiting examples of suitable epoxide monomers can include but are not limited to aliphatic polyepoxides, such as but not limited to 1,2,3,4-diepoxybutane, 1,2,7,8-diepoxyoctane; cycloaliphatic polyepoxides, such as but not limited to 1,2,4,5-diepoxycyclohexane, 1,2,5,6-diepoxycyclooctane, 7-oxa-bicyclo[4.1.0]heptane-3-carboxylic acid 7-oxa-bicyclo[4.1.0]hept-3-ylmethyl ester, 1,2epoxy-4-oxiranyl-cyclohexane and 2,3-(epoxypropyl)cyclohexane; aromatic polyepoxides, such as but not, bis(4-hydroxyphenyl)methane diglycidyl ether; hydrogenated bisphenol A diepoxide; and mixtures thereof. The epoxide prepolymer for use in the present invention can include the reaction product of an epoxide monomer with an active hydrogen material. Non-limiting examples of epoxide monomers and active hydrogen materials can include those previously recited herein. Further, methods of preparing the epoxide prepolymer can include those methods previously discussed relative to reacting a polycyanate prepolymer with an active hydrogen material.

In a non-limiting embodiment, an epoxide prepolymer can be prepared by reacting a polyol and an epihalohydrin, such as but not limited to epichlorohydrin. In a further embodiment, an epoxide monomer can be prepared by reacting a bisphenol, such as but not limited to 4,4′-isopropylidenediphenol, and an epichlorohydrin, such as but not limited to 4,4′-isopropylidenediphenol diglycidyl ether.

In addition to the polymerizable monomer component, the polymerizable composition of the present invention comprises a nanoparticle material. The nanoparticle material can be chosen such that the polymerizable composition of the present invention when at least partially cured, has a refractive index of from 1.595 to 1.695. In a non-limiting embodiment, the particles of the nanoparticle material can have an average particle size of from 5 to 100 nm. In another non-limiting embodiment, the refractive index of the nanoparticle material can be greater than 1.7. In a further non-limiting embodiment, the refractive index of the nanoparticle material can be greater than the refractive index of the polymerizable monomer component. In still a further non-limiting embodiment, the nanoparticle material can be chosen such that when at least partially cured, the polymerizable composition of the present invention results in a transparent material suitable for ophthalmic applications. The average particle size of the particles of the nanoparticle material can be determined by various methods that are known to the skilled artisan. In a non-limiting embodiment, the particle size can be determined using light scattering techniques, such as a Coulter LS particle size analyzer which is manufactured and commercially available from Beckman Coulter Incorporated. As used herein and in the claims, “particle size” refers to the diameter of the particle based on volume percent as determined by light scattering using a Coulter Counter LS particle size analyzer. In this light scattering technique, the diameter is determined from a hydrodynamic radius of gyration regardless of the actual shape of the particle. The “average” particle size is the average diameter of the particle based on volume percent.

Suitable nanoparticle materials for use in the present invention can include a wide variety of nanoparticle materials known in the art which are chemically compatible with the polymerizable monomer component of the present invention. In a non-limiting embodiment, the nanoparticle material can include those nanoparticle materials that do not cause perceptible light scattering. Non-limiting examples of suitable nanoparticle materials can include but are not limited to oxides, mixed oxides, alloys, metals, sulfides, carbides, tellurides, selenides, and nitrides, and mixtures thereof, such as but not limited to silicon, aluminum, indium, tungsten, cobalt, iridium, tin, zirconium, antimony, ruthenium, yttrium, titanium, tantalum, niobium, strontium, cadmium, lead, barium, magnesium, chromium, and strontium titanate, and mixtures thereof. Non-limiting examples of elemental nanoparticle materials can include but are not limited to diamond and sulfur.

The nanoparticle material can be incorporated with the polymerizable monomer component to produce the polymerizable composition of the present invention, using a wide variety of methods known to a skilled artisan. Such methods can include but are not limited to techniques for dispersing, dissolving, diffusing or combinations thereof In a non-limiting embodiment of the present invention, the nanoparticle material can be incorporated by dispersion techniques known to one having ordinary skill in the art. Such dispersion techniques can include but are not limited to ultrasonication, solution blending, sol-gel synthesis, and solution precipitation.

In a non-limiting embodiment, as is known to one having ordinary skill in the art, the method of solution blending can include preparing a solution containing nanoparticle material dispersed in a solvent; blending the solution in a monomer matrix employing rapid agitation; and then evaporating the solvent. A wide variety of solvents known in the art for dispersing particles can be used. Non-limiting examples of suitable solvents can include but are not limited to water, ketones, tetrahydrofuran, alcohols, esters, ethers, aromatic solvents such as benzene, toluene, xylenes, pyrrole, and pyrrollidones, and mixtures thereof. In a further non-limiting embodiment, surface modifiers can be used in dispersing the nanoparticle material. Non-limiting examples of suitable surface modifiers for use in the present invention can include but are not limited to acrylics, silicon derivatives, surfactants, homopolymers, copolymers and mixtures thereof.

In another non-limiting embodiment, as is known to one having ordinary skill in the art, the method of sol-gel synthesis can include hydrolyzing and condensing a sol-gel precursor in the polymerizable monomer component to produce metal oxide in-situ. Suitable sol-gel precursors can include a wide variety known to one having ordinary skill in the art. Non-limiting examples can include but are not limited to metal alkoxides, such as titanium isoproxide, tin ethoxide, aluminum s-butoxide, antimony ethoxide, barium isopropoxide, and hafnium ethoxide. In a further non-limiting embodiment, solvent generated by this process can be evaporated out of the system using conventional techniques known in the art. In a further non-limiting embodiment, surface modifiers can be used in dispersing the nanoparticle material. Non-limiting examples of suitable surface modifiers can include those previously recited herein.

In a further non-limiting embodiment, as is known to one having ordinary skill in the art, the method of solution precipitation can include precipitating nanoparticle material from its salt in a desired monomer matrix; and evaporating the resultant solvent out of the system using conventional techniques known in the art. In a non-limiting embodiment, silica (such as, silcon oxide) can be precipitated by dissolving sodium silicate in water and titrating with an acid such as but not limited to hydrochloric acid.

The amount of nanoparticle material employed in the polymerizable composition of the present invention can vary widely and will depend upon the nanoparticle material selected, the polymerizable monomer component employed, the desired refractive index of the resultant polymerizate, and combinations thereof. In alternate non-limiting embodiments, the amount of nanoparticle material present can be at least 0.5 percent by weight, or at least 10 percent by weight, or at least 25 percent by weight, or at least 45 percent by weight, of the polymerizable composition. In further alternate non-limiting embodiments, the amount of nanoparticle material present can be no greater than 50 percent by weight, or no greater than 35 percent by weight, of the polymerizable composition.

In another non-limiting embodiment, the nanoparticle material can comprise a surface modification or treatment. Such surface modification or treatment can include a variety of modifying chemicals and methods which are known in the art. As can be appreciated by one skilled in the art, the modifying chemical can also be referred to as a coupling agent.

In a non-limiting embodiment, the modifying chemical can be a combination of functionalizing agent and hydrophobizing agent. As used herein and the claims, the term “functionalizing agent” refers to a reactive chemical which can cause a nanoparticle material to covalently bond to a polymerizable composition in which it is used; and the term “hydrophobizing agent” refers to a chemical which can bind and/or be associated with a nanoparticle material such that the affinity for water of the nanoparticle material is reduced, and the affinity for the polymerizable composition in which it is used, is enhanced. Suitable functionalizing agents for use in the present invention can include materials having the following reactive groups, vinyl, epoxy, glycidoxy, (meth)acryloxy, sulfide, polysulfide, mercapto, and combinations thereof. Suitable hydrophobizing agents can include but are not limited to natural or synthetic fats and oils, non-sulfur organometallic compounds, and mixtures thereof.

The amount of functionalizing agent and hydrophobizing agent employed can vary widely and will depend upon the agents selected for use in the present invention. In a non-limiting embodiment, the weight ratio of functionalizing agent to hydrophobizing agent can be least 0.05:1, or from 0.05:1 to 10:1, or from 0.1:1 to 5:1, or from 0.2:1 to 2:1, or from 0.5:1 to 1:1.

In a non-limiting embodiment, the functionalizing agent can be chosen from mercaptoorganometallic compounds, bis(alkoxysilylalkyl)polysulfides, and mixtures thereof. Non-limiting examples of suitable mercaptoorganometallic compounds can include but are not limited to those materials represented by Formula I:

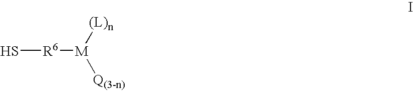

wherein M can be silicon, L can be halogen or —OR⁷, Q can be hydrogen, C₁-C₁₂ alkyl, or halosubstituted C₁-C₁₂ alkyl, R⁶ can be C₁-C₁₂ alkylene, R⁷ can be C₁-C₁₂ alkyl or alkoxyalkyl containing from 2 to 12 carbon atoms, said halogen or (halo) groups can be chloro, bromo, iodo or fluoro, and n can be 1, 2 or 3. In a non-limiting embodiment, R⁶ can be C₁-C₃ alkylene such as but not limited to methylene, ethylene, and propylene, R⁷ can be C₁-C₄ alkyl, or methyl and ethyl, L can be —OR⁶, and n can be 3.

In a non-limiting embodiment, the mercaptoorganometallic compound can have at least two mercapto groups. In another non-limiting embodiment, the mercaptoorganometallic compound can have at least one blocked mercapto group. As used herein and the claims, the term “blocked” means that the mercapto hydrogen atom is replaced by another group. In a further non-limiting embodiment, the blocked mercaptoorganometallic compound can have an unsaturated heteroatom or carbon bonded directly to a sulfur atom via a single bond. Non-limiting examples of suitable blocking groups can include but are not limited to thiocarboxylate ester, dithiocarbamate ester, thiosulfonate ester, thiosulfate ester, thiophosphate ester, thiophosphonate ester, thiophosphinate ester, and mixtures thereof.

In a non-limiting embodiment, the mercaptoorganometallic compound can include but is not limited to mercaptomethyltrimethoxysilane, mercaptoethyltrimethoxysilane, mercaptopropyltrimethoxysilane, mercaptomethyltriethoxysilane, mercaptoethyltripropoxysilane, mercaptopropyltriethoxysilane, (mercaptomethyl)dimethylethoxysilane, (mercaptomethyl)methyldiethoxysilane, 3-mercaptopropyl-methyldimethoxysilane, and mixtures thereof.

In another non-limiting embodiment, the blocked mercaptoorganometallic compound can include blocked mercaptosilanes such as but not limited to 2-triethoxysilyl-1-ethyl thioacetate, 3-trimethoxy-silyl-1-propyl thiooctoate, bis-(3-triethoxysilyl-1 propyl)-methyldithiophosphonate, 3-triethoxysilyl-1-propyldimethylthiophosphinate, 3triethoxysilyl-1-propylmethylthiosulfate, 3-triethoxysilyl-1-propyltoluenethiosulfonate, and mixtures thereof.

Non-limiting examples of suitable bis(alkoxysilylalkyl)polysulfides for use in the present invention can include but are not limited to those materials represented by Formula II:

Z-alk-S_{n′}-alk-Z, II

wherein alk can be a divalent hydrocarbon radical having from 1 to 18, or 1 to 6, or 2 to 3, carbon atoms; n′ can be a whole number of 2 to 12, or 2 to 6, or 3 to 4; and Z can be:

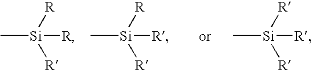

wherein R can be an alkyl group having from 1 to 4 carbon atoms or phenyl, and R′ can be an alkoxy group having from 1 to 8, or 1 to 4, or 1 to 2, carbon atoms, a cycloalkoxy group having from 5 to 8 carbon atoms, or a straight or branched chain alkylmercapto group having from 1 to 8 carbon atoms. The R and R′ groups can be the same or different. The divalent alk group can be straight or branched chain, a saturated or unsaturated aliphatic hydrocarbon group or a cyclic hydrocarbon group.

In a non-limiting embodiment, the bis(alkoxysilylalkyl)-polysulfide can include but is not limited to bis(2-trialkoxysilylethyl)-polysulfide in which the trialkoxy group can be trimethoxy, triethoxy, tri(methylethoxy), tripropoxy, tributoxy, up to trioctyloxy and the polysulfide can be di-, tri-, tetra-, penta-, and hexasulfide; bis(3-trialkoxysilylpropyl)-, bis(3-trialkoxysilylisobutyl), -bis(4-trialkoxysilylbutyl)-, up to bis(6-trialkoxysilylhexyl)polysulfide; 3,3′-bis(trimethoxysilylpropyl)disulfide; 3,3′-bis(triethoxysilylpropyl)tetrasulfide; 3,3′-bis(trimethoxysilylpropyl)tetrasulfide; 2,2′-bis(triethoxysilylethyl)tetrasulfide; 3,3′-bis(trimethoxysilylpropyl)trisulfide; 3,3′-bis(triethoxysilylpropyl)trisulfide; 3,3′-bis(tributoxysilylpropyl)disulfide; 3,3′-bis(trimethoxysilylpropyl)hexasulfide; 3,3′-bis(trioctoxysilylpropyl)tetrasulfide; and mixtures thereof.

In a further non-limiting embodiment, the bis(alkoxysilylalkyl)-polysulfide can be 3,3′-bis(triethoxysilylpropyl)tetrasulfide (TESPT), which can be commercially obtained from Degussa Corporation under the trade name Si-69.

In a non-limiting embodiment, the functionalizing agent of the present invention is a combination of bis(alkoxysilylalkyl)polysulfide and sulfur-containing organometallic compound. Suitable bis(alkoxysilylalkyl)polysulfides and sulfur-containing organometallic compounds include those previously recited herein. The amount of bis(alkoxysilylalkyl)polysulfide and sulfur-containing organometallic compound employed can vary widely. In a non-limiting embodiment, the weight ratio of bis(alkoxysilylalkyl)polysulfide to sulfur-containing organometallic compound can be at least greater than 1:1, or from 1.01: to 100:1, or from 5:1 to 50:1 or from 10:1 to 30:1.

Non-limiting examples of suitable hydrophobizing agents for use in the present invention can include non-sulfur organometallic compounds such as but not limited to those materials represented by the chemical Formulas III, IV, V, VI, and mixtures thereof,

R¹ₐMX₍₄₋ₐ₎ III

R²_{2c+2}Si_{c}O_{(c-1)} IV

R³_{2d}Si_{d}O_{d} V

(R²₃Si)ₖNR⁴₍₃₋ₖ₎ VI

wherein each M can be independently silicon, titanium or zirconium; each R¹ can be independently a hydrocarbon group of from 1 to 18 carbon atoms or R¹ can be an organofunctional hydrocarbon group of from 1 to 12 carbon atoms where, for example the functionality can be amino, carboxylic acid, carbinol ester, or amido; each X can be independently selected from the group consisting of halogen, amino, alkoxy groups of from 1 to 12 carbon atoms and acyloxy groups of from 1 to 12 carbon atoms, a can be the integer 1, 2 or 3; each R² can be independently halo, hydroxy, or a hydrocarbon group containing from 1 to 18 carbon atoms with the proviso that at least 50 mole percent of the R² substituents are hydrocarbon groups containing from 1 to 18 carbon atoms, c can be an integer from 2 to 10,000; each R³ can be independently halo, hydroxy, or a hydrocarbon group containing from 1 to 18 carbon atoms and d can be an integer from 3 to 20; each R⁴ can be independently hydrogen or a hydrocarbon group containing from 1 to 18 carbon atoms and k can be 1 or 2; and the halogen or (halo) groups can be selected from chloro, bromo, iodo or fluoro.

In a non-limiting embodiment, each R¹ can be a saturated or unsaturated monovalent hydrocarbon group or a substituted or non-substituted monovalent hydrocarbon group. R¹ can be, for example, alkyl groups such as but not limited to methyl, ethyl, propyl, iso-propyl, iso-butyl, t-butyl, n-butyl, pentyl, hexyl, heptyl, octyl, nonyl, decyl, and dodecyl; alkenyl groups such as but not limited to vinyl, allyl, and hexenyl; substituted alkyl group such as but not limited to chloromethyl, 3,3,3trifluoropropyl, and 6-chlorohexyl; cycloalkyl groups, such as but not limited to cyclohexyl and cyclooctyl; aryl groups such as but not limited to phenyl and naphthyl; and substituted aryl groups such as but not limited to benzyl, tolyl and ethylphenyl.

In a non-limiting embodiment, the non-sulfur organometallic compound can be an organosilicon compound such as but not limited to diethyldichlorosilane, allylmethyldichlorosilane, methylphenyldichlorosilane, phenylethyldiethoxysilane, 3,3,3-trifluoropropylmethyldichlorosilane, trimethylbutoxysilane, symdiphenyltetramethyldisiloxane, trivinyltrimethyl-cyclotrisiloxane, octamethylcyclotetrasiloxane, hexaethyldisiloxane, pentylmethyldichlorosilane, divinyldipropoxysilane, vinyldimethylchlorosilane, vinylmethyldichlorosilane, vinyldimethylmethoxysilane, trimethylchlorosilane, trimethylmethoxysilane, trimethylethoxysilane, methyltrichlorosilane, methyltrimethoxysilane, methyltriethoxysilane, hexamethyldisiloxane, hexenylmethyldichlorosilane, hexenyldimethylchlorosilane, dimethylchlorosilane, dimethyldichlorosilane, dimethyldimethoxysilane, dimethyldiethoxysilane, hexamethyldisilazane, trivinyltrimethylcyclotrisilazane, polydimethylsiloxanes comprising 3 to about 20 dimethylsiloxy units and trimethylsiloxy or hydroxydimethylsiloxy end blocked poly(dimethylsiloxane) polymers having an apparent viscosity within the range of from 1 to 1000 in mPa·s at 25° C., and mixtures thereof.

In a non-limiting embodiment, the non-sulfur organometallic compound can be an organotitanium compound such as but not limited to tetra(C₁-₁₈)alkoxy titanates, methyl triethoxy titanium (iv), methyl titanium (iv) triisopropoxide, methyl titanium (iv) tributoxide, methyl titanium (iv) tri-t-butoxide, isopropyl titanium (iv) tributoxide, butyl titanium (iv) triethoxide, butyl titanium (iv) tributoxide, phenyl titanium (iv) triisopropoxide, phenyl titanium (iv) tributoxide, phenyl titanium (iv) triisobutoxide, [Ti(CH₂Ph)₃ (NC₅H₁₀)] and [Ti(CH₂SiMe₃)₂(NEt₂)₂], and mixtures thereof.

In a non-limiting embodiment, the non-sulfur organometallic compound can be an organozirconium compound such as but not limited to tetra(C₁-C₁₈)alkoxy zirconates, phenyl zirconium (iv) trichloride, methyl zirconium (iv) trichloride, ethyl zirconium (iv) trichloride, propyl zirconium (iv) trichloride, methyl zirconium (iv) tribromide, ethyl zirconium (iv) tribromide, propyl zirconium (iv) tribromide, chlorotripentyl zirconium (iv), and mixtures thereof.

In a non-limiting embodiment, the reaction of the functionalizing agent and hydrophobizing agent can include a solvent. Suitable solvents for use in the present invention are both numerous and widely varied, as is appreciated by one having ordinary skill in the art. In a non-limiting embodiment, the solvent can be a water-miscible organic solvent. Non-limiting examples of suitable water-miscible organic solvents can include but are not limited to alcohols such as but not limited to ethanol, isopropanol and tetrahydrofuran. The amount of solvent used can vary widely and will depend upon the selection of the solvent, functionalizing agent, hydrophobizing agent, and combinations thereof. In alternate non-limiting embodiments, the solvent can constitute at least 5 weight percent of the aqueous suspension, or not more than 50 weight percent, or from 20 to 30 weight percent.

In a further non-limiting embodiment, a surfactant can be employed. There are numerous and varied surfactants known in the art which would be suitable for use in the present invention. Generally, a surfactant can be suitable for use in the present invention provided it does not produce substantially adversely effect the chemical modification reaction. Suitable surfactants can include nonionic, anionic, cationic and amphoteric surfactants, and mixtures thereof. Non-limiting examples of suitable surfactants can include alkylphenolpolyglycol ethers, such as but not limited to p-octylphenolpolyethyleneglycol (20 units) ether, p-nonylphenolpolyethyleneglycol (20 units) ether, alkylpolyethyleneglycol ethers, such as but not limited to dodecylpolyethyleneglycol (20 units) ether, polyglycols, such as but not limited to polyethyleneglycol 2000, alkyltrimethylammonium salts, such as but not limited to cetyltrimethylammonium chloride (or bromide), dialkyldimethylammonium salts, such as but not limited to dilauryldimethylammonium chloride, alkylbenzyltrimethylammonium salts, alkylbenzenesulfonates, such as but not limited to sodium pdodecylbenzenesulfonate, sodium p-nonylbenzenesulfonate, alkylhydrogen sulfates, such as but not limited to lauryl hydrogen sulfate, and alkyl sulfates, such as but not limited to lauryl sulfate.

The amount of surfactant used can vary widely and will depend upon the selection of the surfactant, functionalizing agent, hydrophobizing agent and combinations thereof. In general, the surfactant can be present in an amount sufficient to facilitate the chemical modification reaction. In alternate non-limiting embodiments, the surfactant can be present in an amount of from 0.05 to 10 weight percent of the aqueous suspension, or from 0.1 to 5 weight percent, or from 0.1 to 3 weight percent.

In addition to the polymerizable monomer component and the nanoparticle material which can be optionally surface modified, the polymerizable composition of the present invention can optionally include one or more additives known to one having ordinary skill in the art. Such additives can include but are not limited to catalysts, initiators, mold release agents, dyes, polymerization inhibitors, stabilizers, other polymers, polyols, polycarboxylic acids, and ethylenically unsaturated aromatic-containing compounds. This list of optional ingredients is not exhaustive; as is appreciated by the skilled artisan, a wide variety of such ingredients are known in the art. These and other ingredients can be employed in their customary amounts for their customary purposes provided that they do not substantially interfere with formulating the polymerizable composition and resulting polymerizate.

In a non-limiting embodiment, a catalyst can be present in the polymerizable composition of the present invention to increase the rate of polymerization. Suitable catalysts can be chosen from a wide variety of known polymerization catalysts. Non-limiting examples of catalysts can include the group of Lewis bases, Lewis acids and insertion catalysts described in Ullmann's Encyclopedia of Industrial Chemistry, 5^{th} Edition, 1992, Volume A21, pp. 673 to 674. In a non-limiting embodiment, the catalyst can be a stannous adduct of an organic acid, such as but not limited to stannous octoate, dibutyl tin dilaurate, dibutyl tin diacetate, dibutyl tin mercaptide, dibutyl tin dimaleate, dimethyl tin diacetate, dimethyl tin dilaurate, 1,4-diazabicyclo[2.2.2]octane, and mixtures thereof. In alternate non-limiting embodiments, the catalyst can be zinc octoate, bismuth, or ferric acetylacetonate.

Further non-limiting examples of suitable catalysts can include tertiary amines such as but not limited to triethylamine, triisopropylamine and N,N-dimethylbenzylamine. Such suitable tertiary amines are disclosed in U.S. Pat. No. 5,693,738 at column 10, lines 6-38, the disclosure of which is incorporated herein by reference. In alternate non-limiting embodiments, tertiary amine or organo tin catalysts can be employed.

The amount of polymerization catalyst used can vary widely. In a further non-limiting embodiment, the polymerization catalyst can constitute from about 50 to about 10,000 parts of polymerization catalyst per million parts of polymerizable, essentially homogeneous composition by weight. The amount of polymerization catalyst used will depend upon the activity of a particular catalyst and the pot-life desired. In a further non-limiting embodiment, initiators can be added to the polymerizable composition of the present invention to polymerize the polymerizable composition. In general, initiators are known in the art to be capable of generating free radicals. Suitable initiators can be chosen from a wide variety of initiators known in the art. In general, suitable initiators are at least substantially thermally decomposable to produce radical pairs. Suitable initiators for use in the present invention can include but are not limited to peroxy initiators and azobis(organonitrile) compounds. The amount of initiator present in the polymerizable composition can vary widely. As is appreciated by a skilled artisan, the weight ratio of initiator will depend upon the particular initiator used, as well as the other components and their amounts present in the polymerizable composition. In a non-limiting embodiment, as one skilled in the art will appreciate, an initiating amount of an initiator can be used. As used herein and the claims, an “initiating amount” refers to that amount required to initiate the polymerization reaction. In a non-limiting embodiment, the initiator can be incorporated into a polymerizable, substantially liquid, substantially gel-free composition by admixing it with the other components.

Non-limiting examples of suitable organic peroxy compounds can include but are not limited to peroxymonocarbonate esters, such as tertiarybutylperoxy 2-ethylhexyl carbonate and tertiarybutylperoxy isopropyl carbonate; peroxyketals, such as 1,1-di-(t-butyl peroxy)-3,3,5-trimethylcyclohexane; peroxydicarbonate esters, such as di(2ethylhexyl) peroxydicarbonate, di(secondary butyl) peroxydicarbonate and diisopropylperoxydicarbonate; diacyperoxides, such as 2,4-dichlorobenzoyl peroxide, isobutyryl peroxide, decanoyl peroxide, lauroyl peroxide, propionyl peroxide, acetyl peroxide, benzoyl peroxide, p-chlorobenzoyl peroxide; peroxyesters such as t-butylperoxy pivalate, t-butylperoxy octylate, and t-butylperoxyisobutyrate; methylethylketone peroxide, and acetylcyclohexane sulfonyl peroxide.

Non-limiting examples of suitable azobis(organonitrile) compounds can include but are not limited to azobis(isobutyronitrile) and azobis(2,4-dimethylvaleronitrile).

In a non-limiting embodiment of the present invention, the polymerizable composition can be prepared by admixing the polymerizable monomer component, the nanoparticle material and any optional ingredients previously recited herein. In another non-limiting embodiment, mixing can be accompanied with heating when it is desirable to hasten dissolution of any of the ingredients. In a further non-limiting embodiment, the temperature can be maintained below that temperature at which substantial polymerization commences.

In a non-limiting embodiment, the polymerizable composition of the invention can be pourable. The term “pourable” as used herein and in the claims refers to the viscosity of the material being sufficiently low such that it can be poured into conventional molds used in casting ophthalmic lenses and lens blanks. In a non-limiting embodiment, the temperature of the polymerizable composition when poured into molds can be from 20° C. to 150° C.

In a non-limiting embodiment, the polymerizable composition of the present invention can be conformed to a desired shape of the resulting polymerized article prior to the polymerization process. In a non-limiting embodiment, the polymerizable composition can be essentially a liquid poured into a flat surface and polymerized to form a flat sheet or coating. In another non-limiting embodiment, the polymerizable composition can be essentially a liquid placed in molds, such as glass molds, and polymerized to form shaped articles such as lens blanks or lenses. The present invention can be particularly useful for the preparation of ophthalmic lens blanks and ophthalmic lenses.

Polymerization of the polymerizable composition of the present invention can be accomplished by various conventional techniques known to one having ordinary skill in the art. The polymerization technique employed will generally depend upon the selections made for the polymerizable monomer component, nanoparticle material, and optional additives. In a non-limiting embodiment, polymerization can be accomplished by heating the polymerizable composition to elevated temperatures. The polymerizable composition can be heated using a wide variety of conventional techniques known in the art. For example, methods for polymerizing a composition having monomer(s) which contain radically polymerizable group(s) are well known to the skilled artisan and any of those well known techniques can be used. Such polymerization methods can include but are not limited to thermal polymerization, photopolymerization or a combination thereof.

In general, thermal polymerization can include heating the polymerizable composition in an oven or in a water bath. The temperature to which the polymerizable composition is heated can vary widely and will depend upon the monomer and other components selected for use in the composition. In a further non-limiting embodiment, the polymerization can be conducted at a temperature of from 20° C. to 150° C.

In a non-limiting embodiment, an initiator can be used in the thermal polymerization of the polymerizable composition. Suitable initiators and their amounts can be selected from those previously recited herein. In a non-limiting embodiment, a thermal initiator which does not discolor the resulting polymerizate can be employed. In another non-limiting embodiment, 1,1-di-(t-butyl peroxy)-3,3,5-trimethylcyclohexane, which is commercially available from Elf Atochem under the tradename LUPERSOL® 231, can be used. In further alternate non-limiting embodiments, the 1,1-di-(t-butyl peroxy)-3,3,5-trimethylcyclohexane can be present in an amount of from 0.01 to 3.0, or from 0.05 to 1.0, parts per 100 parts of monomers (phm) present in the polymerizable composition.

In another non-limiting embodiment, the thermal polymerization of the polymerizable composition can be accomplished by heating the polymerizable composition in the presence of an initiator from room temperature to a temperature of from 50° C. to 150° C. over a period of from 2 hours to 48 hours.

In another non-limiting embodiment, the polymerizable composition of the present invention can be polymerized by photopolymerization. Photopolymerization techniques are known to one having ordinary skill in the art. Such known photopolymerization techniques are suitable for use in the present invention. In general, the light source employed in photopolymerization techniques can include ultraviolet light, visible light, and combinations thereof. Suitable ultraviolet light sources can include but are not limited to mercury lamps, germicidal lamps or xenon lamps. A suitable visible light source can include but is not limited to sunlight. The exposure time of the polymerizable composition to the light source can vary and will depend upon the wavelength and intensity of the light source and the shape of the mold.

In a further non-limiting embodiment, the photopolymerization process can be carried out in the presence of a photopolymerization initiator. Photopolymerization initiators known in the art are numerous and widely varied. Such known photopolymerization initiators can be suitable for use in the present invention. Suitable initiators and their amounts can be selected from those previously recited herein. In a non-limiting embodiment, the photopolymerization initiator can include benzoin, benzoin methyl ether, benzoin isobutyl ether, benzophenone, acetophenone, 4,4′-dichlorobenzophenone, diethoxyacetophenone, 2-hydroxy-2-methyl-1-phenylpropan-1 one, 1-hydroxycyclohexyl phenyl ketone, 2-isopropylthixanthone, 2,4,6trimethylbenzoyldiphenylphosphine oxide, and mixtures thereof.

In another non-limiting embodiment, the polymerizable composition of the present invention can undergo photopolymerization in the presence of diphenyl (2,4,6trimethylbenzoyl)phosphine oxide as initiator, in an amount of from 0.01 percent to 2 percent by weight, based on the total weight of the polymerizable monomer component.

In a further non-limiting embodiment, the amount of thermal polymerization initiator or photopolymerization initiator employed can be such that the resultant polymerizate has a 15 second Barcol hardness of at least 1, or at least 4, or from 4 to 35.

The polymerizable composition of the present invention can be cured using a variety of conventional curing techniques known to one having ordinary skill in the art. Generally, curing a polymerizable composition includes the use of heat and/or chemicals to induce a permanent chemical change to the composition, resulting in an insoluble product which can demonstrate good thermal and dimensional stability. Further, as used herein and the claims, the term “curing” and related terms refers to at least partial crosslinking of the polymerizable composition. In alternate non-limiting embodiments, crosslinking can occur as a result of free radical polymerization or a condensation reaction mechanism. In a further non-limiting embodiment, a curing agent can be employed to assist in the cross-linking or curing process. Numerous and varied curing agents known in the art are suitable for use in the present invention. In general, selection of a curing agent will depend on the ingredients of the polymerizable composition. Suitable curing agents can include but are not limited to sodium chloride, sodium nitrite, sulfur-containing materials, glycols and amine-containing materials.

In a non-limiting embodiment, the polymerizable composition of the invention can be polymerized and cured to a thermosetting material. As used herein and the claims, the term “thermosetting” refers to a material that is capable of becoming permanently rigid when heated or cured. The structural shape of polymer molecules and the characterization of thermosetting materials are known in the art. (See Principles of Polymerization, George Odian, McGraw-Hill, Inc., 1970, pages 16-19 and 94-99.) It is generally known in the art that the presence of crosslinking and/or the extent of crosslinking can be controlled by the stoichiometry and/or curing conditions used in preparing the polymer.

In a non-limiting embodiment, a thermosetting polyurethane can be prepared by using less than the stoichiometrically required amount of curing agent such that the urethane or urea linkages will react with remaining isocyanates. In another non-limiting embodiment, the partial replacement of difunctional by trifunctional curing agents or isocyanates can result in more thermally stable chemical crosslinks.

In another non-limiting embodiment, the curing agent for use in the present invention can include an amine-containing curing agent. In a further non-limiting embodiment, the curing agent can be a polyamine having more than one amino group per molecule, each amino group being independently selected from primary amino (—NH₂) and secondary amine (—NH—) groups. In alternate non-limiting embodiments, the amine-containing curing agent can be chosen from aliphatic polyamines, cycloaliphatic polyamines, aromatic polyamines, and mixtures thereof. In a further non-limiting embodiment, the amino groups are all primary groups. In another non-limiting embodiment wherein it is desirable to produce a product having low color, the amine-curing agent can be chosen such that it has relatively low color and/or it can be manufactured and/or stored in a manner as to prevent the amine from developing a color (e.g., yellow).

Suitable amine-containing curing agents for use in the present invention can include but are not limited to materials having the following chemical formula:

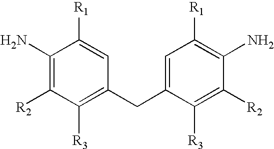

wherein R₁ and R₂ can each be independently chosen from methyl, ethyl, propyl, and isopropyl groups, and R₃ can be chosen from hydrogen and chlorine. Non-limiting examples of amine-containing curing agents for use in the present invention include the following compounds, manufactured by Lonza Ltd. (Basel, Switzerland):

LONZACURE.RTM. M-DIPA: R₁═C₃H₇; R₂═C₃H₇; R₃═H

LONZACURE.RTM. M-DMA: R₁═CH₃; R₂═CH₃; R₃═H

LONZACURE.RTM. M-MEA: R₁═CH₃; R₂═C₂H₅; R₃═H

LONZACURE.RTM. M-DEA: R₁═C₂H₅; R₂═C₂H₅; R₃═H

LONZACURE.RTM. M-MIPA: R₁═CH₃; R₂═C₃H₇; R₃═H

LONZACURE.RTM. M-CDEA: R₁═C₂H₅; R₂═C₂H₅; R₃═CI

wherein R₁, R₂ and R₃ correspond to the aforementioned chemical formula.

In a non-limiting embodiment, the amine-containing curing agent can include but is not limited to a diamine curing agent such as 4,4′-methylenebis(3-chloro-2,6diethylaniline), (Lonzacure.RTM. M-CDEA), which is available in the United States from Air Products and Chemical, Inc. (Allentown, Pa.). In alternate non-limiting embodiments, the amine-containing curing agent for use in the present invention can include 2,4diamino-3,5-diethyl-toluene, 2,6-diamino-3,5-diethyl-toluene and mixtures thereof (collectively “diethyltoluenediamine” or “DETDA”), which is commercially available from Albemarle Corporation under the trade name Ethacure 100; dimethylthiotoluenediamine (DMTDA), which is commercially available from Albemarle Corporation under the trade name Ethacure 300; 4,4′-methylene-bis-(2-chloroaniline) which is commercially available from Kingyorker Chemicals under the trade name MOCA. DETDA can be a liquid at room temperature with a viscosity of 156 cPs at 25° C. DETDA can be isomeric, with the 2,4-isomer range being from 75 to 81 percent while the 2,6-isomer range can be from 18 to 24 percent.

In a non-limiting embodiment, the color stabilized version of Ethacure 100 (i.e., formulation which contains an additive to reduce yellow color), which is available under the name Ethacure 100S may be used in the present invention.

In another embodiment, the amine-containing curing agent for use in the present invention can be chosen from DEDTA, compounds having the following structure

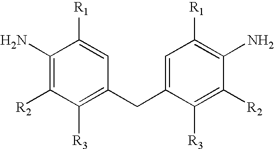

and mixtures thereof.

In a further non-limiting embodiment, post curing of the polymerizable composition can be employed. As used herein and the claims, the term “post curing” refers to heating the polymerizable composition for a time period beyond the time necessary to substantially polymerize the polymerizable composition. In a further non-limiting embodiment, the post cure can be carried out at temperatures that match or exceed the maximum temperature of the cure cycle, but below the temperature at which thermal degradation provides undesirable yellowness. In alternate non-limiting embodiments, the post cure can be carried out for a period of time sufficient to attain either substantially constant or maximum Barcol hardness. In a further non-limiting embodiment, the post cure can be conducted at a temperature of from 50° C. to 150° C.

Polymerizates obtained from polymerizing and at least partially curing the polymerizable compositions of the present invention will be solid. In a non-limiting embodiment, the solid article can be transparent. As used herein and the claims, “transparent” means that the article is suitable for optical or ophthalmic applications. In further alternate non-limiting embodiments, a transparent lens can be at least 50% transparent in the visible region of light, or at least 50% transparent in a range of from 400 to 700 nm wavelength of light.

Non-limiting examples of solid articles that can be prepared from the polymerizable composition of the present invention can include but are not limited to, optical lenses, such as piano and ophthalmic lenses, sun lenses, windows, automotive transparencies, such as windshields, sidelights and backlights, and aircraft transparencies.

The polymerizates of the present invention will have a refractive index of at least 1.58, or from 1.595 to 1.695. In a non-limiting embodiment, the polymerizates of the present invention can have an Abbe number of from 25 to 35, or at least 33 or at least 35.

In a non-limiting embodiment, the polymerizate of the present invention, on an undyed and untinted basis, can exhibit one or more favorable properties such as but not limited to acceptably low yellowness, high luminous transmission, low haze, and an acceptable 15-second Barcol hardness. In alternate non-limiting embodiments, a six base (i.e., curve of an ophthalmic lens) semi-finished lens with a 6 to 8 mm center thickness, can have a yellowness index of 30 or less, or 12 or less. The yellowness index can be determined using conventional techniques known in the art. As recited herein, the yellowness index is determined in accordance with ASTM Test Method D 1925-70 (Reapproved 1977) using a Hunterlab Tristimulus Colorimeter Model D25P employing a collimated Illuminant C standard light source.

In alternate non-limiting embodiments, the luminous transmission of the polymerizate of the present invention on an undyed and untinted basis can be at least 50 percent, or at least 80 percent. In further alternate non-limiting embodiments, the haze value of the polymerizate on an undyed and untinted basis can be not more than 10 percent, or not more than 5 percent, or not more than 2 percent. As recited herein, luminous transmission and haze values are determined in accordance with ASTM Test Method D 1003-61 (Reapproved 1977) using a Hunterlab Tristimulus Colorimeter Model D25P employing a collimated Illuminant C standard light source.

In a non-limiting embodiment, the polymerizate of the present invention can have an acceptable 15-second Barcol hardness value. In a further non-limiting embodiment, the 15-second Barcol hardness value of the polymerizate of the present invention can be from 1 to 40, when employing a Barcol 934 test. In an alternate non-limiting embodiment, the 15-second Barcol hardness value can be from 55 to 100, when employing a Barcol 935 test. In another non-limiting embodiment, the 15-second Barcol hardness of the polymerizate can be determined using a Fischer Micro-hardness test, in accordance with CEN ISO 14577, which is incorporated herein by reference. In this embodiment, the 15second Barcol hardness value can be from 15 to 150 N/mm². As recited herein, the 15second Barcol hardness is determined in accordance with ASTM-D 2583-95 using a Barcol Impressor and taking scale readings 15 seconds after the impressor point has penetrated the specimen. ASTM-D 2583-95 is incorporated herein by reference.

In a further non-limiting embodiment, the polymerizate of the present invention can have a low density, as will be appreciated by one having ordinary skill in the art. The density of a polymerizate can be determined using a variety of equipment and methods known to a skilled artisan. In a non-limiting embodiment, the density can be measured using a DensiTECH instrument manufactured by Tech Pro, Incorporated. In a further non-limiting embodiment, the density is measured in accordance with ASTM D297. In alternate non-limiting embodiments, the density can be from greater than 1.0 to less than 1.8 grams/cm³, or from greater than 1.0 to less than 1.3 grams/cm³.

The polymerizable composition of the present invention can be used to produce a photochromic article. Photochromic materials are known to one having ordinary skill in the art. Suitable photochromic materials for use in the present invention can include the numerous and varied ones known by a skilled artisan. In a non-limiting embodiment, the photochromic material can be chosen from the following classes of materials: chromenes, such as but not limited to, naphthopyrans, benzopyrans, indenonaphthopyrans, phenanthropyrans or mixtures thereof; spiropyrans, such as but not limited to spiro(benzindoline)naphthopyrans, spiro(indoline)benzopyrans, spiro(indoline)naphthopyrans, spiro(indoline)quinopyrans and spiro(indoline)pyrans; oxazines, such as but not limited to spiro(indoline)naphthoxazines, spiro(indoline)pyridobenzoxazines, spiro(benzindoline)pyridobenzoxazines, spiro(benzindoline)naphthoxazines and spiro(indoline)benzoxazines; mercury dithizonates; fulgides; fulgimides; and mixtures thereof

Non-limiting examples of photochromic materials are described in the following United States Patents: U.S. Pat. No. 4,931,220 from column 8, line 52 to column 22, line 40; U.S. Pat. No. 5,645,767 from column 1, line 10 to column 12, line 57; U.S. Pat. No. 5,658,501 from column 1, line 64 to column 13, line 17; U.S. Pat. No. 6,153,126 from column 2, line 18 to column 8, line 60; U.S. Pat. No. 6,296,785 from column 2, line 47 to column 31, line 5; U.S. Pat. No. 6,348,604 from column 3, line 26 to column 17, line 15; and U.S. Pat. No. 6,353,102 from column 1, line 62 to column 11, line 64. The cited relevant portion of these patents are incorporated herein by reference. Moreover, suitable spiro(indoline)pyrans are described in the text, Techniques in Chemistry, Volume III, “Photochromism”, Chapter 3, Glenn H. Brown, Editor, John Wiley and Sons, Inc., New York, 1971.

In another non-limiting embodiment, the photochromic material can be a polymerizable photochromic material which can include but is not limited to polymerizable naphthoxazines, such as but not limited to those disclosed in U.S. Pat. No. 5,166,345 from column 3, line 36 to column 14, line 3; polymerizable spirobenzopyrans such as but not limited to those disclosed in U.S. Pat. No. 5,236,958 from column 1, line 45 to column 6, line 65; polymerizable spirobenzopyrans and spirobenzothiopyrans, such as but not limited to those disclosed in U.S. Pat. No. 5,252,742 from column 1, line 45 to column 6, line 65; polymerizable fulgides such as but not limited to those disclosed in U.S. Pat. No. 5,359,085 from column 5, line 25 to column 19, line 55; polymerizable naphthacenediones such as but not limited to those disclosed in U.S. Pat. No. 5,488,119 from column 1, line 29 to column 7, line 65; polymerizable spirooxazines such as but not limited to those disclosed in U.S. Pat. No. 5,821,287 from column 3, line 5 to column 11, line 39; polymerizable polyalkoxylated naphthopyrans such as but not limited to those disclosed in U.S. Pat. No. 6,113,814 from column 2, line 23 to column 23, line 29; and mixtures thereof. Moreover, suitable polymerizable photochromic compounds for use in the present invention are disclosed in WO97/05213 and U.S. patent application Ser. No. 09/828,260 filed Apr. 6, 2001. The cited relevant portions of these patents and patent application are incorporated herein by reference.

Other non-limiting examples of photochromic materials suitable for use in the present invention can include organo-metal dithiozonates, such as but not limited to (arylazo)-thioformic arylhydrazidates, such as but not limited to mercury dithizonates which are described in, for example, U.S. Pat. No. 3,361,706 from column 2, line 27 to column 8, line 43; fulgides and fulgimides, such as but not limited to 3-furyl and 3thienyl fulgides and fulgimides, which are described in U.S. Pat. No. 4,931,220 from column 1, line 39 through column 22, line 41; and mixtures thereof The cited relevant portions of these patents are incorporated herein by reference.

In a non-limiting embodiment, the photochromic material for use in the present invention can include a form of organic photochromic material resistant to the effects of a polymerization initiator. In a further non-limiting embodiment, such organic photochromic materials can include photochromic compounds in admixture with a resinous material that has been formed into particles and encapsulated in metal oxides. Non-limiting examples can include those described in U.S. Pat. No. 4,367,170 from column 1 line 36 to column 7, line 12; which cited relevant disclosure is incorporated herein by reference.

The photochromic material can be associated with the organic polymeric material by various methods described in the art. In alternate non-limiting embodiments, the total amount of photochromic material can be incorporated into the organic polymeric material used to form the photochromic article by methods such as but not limited to adding the photochromic materials to one or more of the materials used to form the organic polymeric material; or imbibing the photochromic materials into the at least partially cured polymerizate. In another non-limiting embodiment, the photchromic material can be incorporated into the organic polymeric material by permeation or transfer methods known in the art. In a further non-limiting embodiment, a polymerizable composition containing photochromic materials can be added or injected into a mold and polymerized by a conventional cast-in-place process. In still a further embodiment, the polymerizable composition which includes highly reactive materials, such as materials used to form polyurethanes, a process such as a conventional reaction-injection-molding can be employed.

As used herein and the claims, the term “imbibition” or “imbibe” is intended to mean and include permeation of the photochromic materials individually or with other non-photochromic materials into the polymerizate, solvent assisted transfer absorption of the photochromic materials into a polymerizate, vapor phase transfer, and other such transfer mechanisms.

In alternate non-limiting embodiments, the photochromic material can include a single photochromic compound; a mixture of at least two photochromic compounds; a material comprising at least one photochromic compound, such as but not limited to a plastic polymeric resin or an organic monomeric or oligomeric solution; a material such as but not limited to a monomer or polymer to which at least one photochromic compound is chemically bonded; and combinations thereof. In a further non-limiting embodiment, the photochromic material can include a material to which at least one photochromic compound is chemically bonded, wherein the outer surface of the material is at least partially coated. In another embodiment, the coating can include encapsulation with a polymeric resin or a protective coating such as but not limited to a metal oxide. In this embodiment, the metal oxide can prevent contact of the photochromic material with external materials such as oxygen, moisture and/or chemicals that can negatively effect the properties of the photochromic material.

The photochromic material can be used in widely varying amounts and ratios. Generally, the photochromic materials are used in such an amount or ratio that an organic polymeric material to which the photochromic materials are associated, exhibits a desired resultant color, such as but not limited to a substantially neutral color when activated with unfiltered sunlight, and an increased level of ultraviolet radiation absorption. In a non-limiting embodiment, the photochromic material can be used to produce articles having a wide range of colors, such as but not limited to pink. U.S. Pat. No. 5,645,767 from column 12, line 66 to column 13, line 19, which is incorporated herein by reference, provides relevant disclosure related to neutral colors.

The amount of photochromic material incorporated into or applied on to an organic polymeric material of the photochromic article of the present invention can vary widely. Generally, the amount used is an amount sufficient to produce the desired level of ultraviolet absorption. Such an amount can be described as an ultraviolet radiation absorbing amount. The amount used will depend upon the desired level of ultraviolet radiation absorption and the expected intensity of the ultraviolet radiation exposure. In a non-limiting embodiment, the more photochromic material applied or incorporated, the greater is the amount of ultraviolet radiation absorbed up to a certain limit. There is a point after which the addition of any more photochromic material will not have a noticeable effect.

We claim:

1. A polymerizable composition comprising a polymerizable monomer component and a nanoparticle material, said polymerizable composition when at least partially cured having a refractive index of from 1.595 to 1.695.

2. The polymerizable composition of claim 1 wherein said polymerizable monomer component is substantially aliphatic.

3. The polymerizable composition of claim 1 wherein said nanoparticle material has an average particle size of from 5 to 100 nm.

4. The polymerizable composition of claim 1 wherein said nanoparticle material has a refractive index of greater than 1.7.

5. The polymerizable composition of claim 1 wherein said nanoparticle material has a refractive index greater than refractive index of said polymerizable monomer component.

6. The polymerizable composition of claim 1 wherein said nanoparticle material is chosen from oxides, mixed oxides, alloys, metals, sulfides, carbides tellurides, selenides, nitrides and mixtures thereof.

7. The polymerizable composition of claim 6 wherein said nanoparticle material is chosen from silicon, aluminum, indium, tungsten, cobalt, iridium, tin, zirconium, antimony, ruthenium, yttrium, titanium, tantalum, niobium, strontium, cadmium, lead, barium, magnesium, chromium, strontium titanate, and mixtures thereof.

8. The polymerizable composition of claim 6 wherein said nanoparticle material is chosen from diamond and sulfur.

9. The polymerizable composition of claim 1 wherein said nanoparticle material comprises a surface modifying chemical.

10. The polymerizable composition of claim 9, wherein said modifying chemical comprises a functionalizing agent and a hydrophobizing agent.

11. The polymerizable composition of claim 10, wherein said functionalizing agent can be chosen from materials having vinyl, epoxy, glycidoxy, (meth)acryloxy, sulfide, polysulfide, and mercapto reactive groups, and combinations thereof.

12. The polymerizable composition of claim 10, wherein said functionalizing agent is chosen from mercaptoorganometallic compounds, bis(alkoxysilylalkyl)polysulfides, and mixtures thereof.

13. The polymerizable composition of claim 10, wherein said hydrophobizing agent is chosen from non-sulfur organometallic compounds.

14. The polymerizable composition of claim 1 wherein said nanoparticle material is present in an amount of from 0.5 percent by weight to no greater than 50% by weight, of the polymerizable composition.

15. The polymerizable composition of claim 1 wherein said polymerizable monomer component is chosen from ethylenically unsaturated monomers, polyol(allyl carbonate) monomers, thiol monomers, polycyanate monomers, polycyanate prepolymers, polyepoxide prepolymers, and mixtures thereof.

16. The polymerizable composition of claim 15 wherein said ethylenically unsaturated monomer is an aromatic monomer having at least two vinyl groups.

17. The polymerizable composition of claim 15 wherein said thiol monomer is a polythiol monomer having at least two thiol groups.

18. The polymerizable composition of claim 15 wherein said polycyanate prepolymer has a number average molecular weight of from 500 to 15,000.

19. The polymerizable composition of claim 1 wherein said polymerizable monomer component comprises a reaction product of:
(a) a prepolymer comprising a polycyanate and at least one active hydrogen material; and
(b) an amine-containing curing agent.

20. The polymerizable composition of claim 19, wherein said active hydrogen material is chosen from polyols, polythiols, materials having both hydroxyl and thiol groups, and mixtures thereof.

21. The polymerizable composition of claim 20 wherein said polyol is chosen from polyether polyols, polyester polyols, polycaprolactone polyols, polycarbonate polyols, polyurethane polyols, and mixtures thereof.

22. An at least partially cured polymerizate of the polymerizable composition of claim 1.

23. The at least partially cured polymerizate of claim 22 having a density of no greater than 1.8 grams/cm³.

24. The at least partially cured polymerizate of claim 22 having an Abbe number of at least 25.

25. An at least partially cured polymerizate of the polymerizable composition of claim 1, said at least partially cured polymerizate having at least 50% transparency in a range of wavelengths from 400 to 700 nanometers.

26. A polymerizable composition, said polymerizable composition comprising nanoparticle material having a surface modification, said polymerizable composition when at least partially cured having a refractive index of from 1.595 to 1.695.

27. A polymerizate comprising the polymerizable composition of claim 19.

28. A polymerizate comprising the polymerizable composition of claim 20.

29. A photochromic article comprising the polymerizable composition of claim 1 and a photochromic amount of organic photochromic substance.

30. A photochromic article comprising the polymerizable composition of claim 19 and a photochromic amount of organic photochromic substance.

31. A method of preparing a polymerizable composition comprising:
(a) obtaining a polyurethane prepolymer;
(b) reacting said prepolymer with an amine-containing curing agent; and
(c) adding nanoparticle material.

32. A method of preparing an at least partially cured polymerizate comprising:
(a) obtaining a polyurethane prepolymer, reacting said prepolymer with an amine-containing curing agent, and adding nanoparticle material to produce a polymerizable composition; and
(b) polymerizing and at least partially curing said polymerizable composition to produce said at least partially cured polymerizate.

33. The method of claim 32 wherein said at least partially cured polymerizate has a refractive index of from 1.595 to 1.695.

34. The method of claim 33 wherein said at least partially cured polymerizate has an Abbe number of at least 25 and a density of no greater than 1.8 grams/cm³.

35. The method of claim 32 wherein said nanoparticle material comprises a surface modifying chemical.

36. An optical article comprising a polymerizable composition which comprises nanoparticle material, said polymerizable composition when at least partially cured having a refractive index of from 1.595 to 1.695.

37. An optical article comprising a polymerizable composition which comprises:
i. a prepolymer comprising an polycyanate and at least one active hydrogen material;
ii. an amine-containing curing agent; and
iii. a nanoparticle material.

38. A photochromic article comprising a polymerizable composition which comprises nanoparticle material, said polymerizable composition when at least partially cured, having a refractive index of from 1.595 to 1.695.

39. A photochromic article comprising a polymerizable composition which comprises:
i. a prepolymer comprising an polyisocyanate and at least one active hydrogen material;
ii. an amine-containing curing agent; and
iii. a nanoparticle material.

40. A polymerizable composition comprising a polymerizable monomer component and a nanoparticle material, said polymerizable composition when at least partially cured having a refractive index of from 1.595 to 1.695, and a density of no greater than 1.8 grams/cm³.

41. The polymerizable composition of claim 40 wherein said polymerizable monomer component is substantially aliphatic.

42. The polymerizable composition of claim 40 wherein said nanoparticle material has an average particle size of from 5 to 100 nm.

43. The polymerizable composition of claim 40 wherein said nanoparticle material has a refractive index of greater than 1.7.

44. The polymerizable composition of claim 40 wherein said nanoparticle material has a refractive index greater than refractive index of said polymerizable monomer component.

45. The polymerizable composition of claim 40 wherein said nanoparticle material is chosen from oxides, mixed oxides, alloys, metals, sulfides, carbides tellurides, selenides, nitrides and mixtures thereof.

46. The polymerizable composition of claim 45 wherein said nanoparticle material is chosen from silicon, aluminum, indium, tungsten, cobalt, iridium, tin, zirconium, antimony, ruthenium, yttrium, titanium, tantalum, niobium, strontium, cadmium, lead, barium, magnesium, chromium, strontium titanate, and mixtures thereof.

47. The polymerizable composition of claim 45 wherein said nanoparticle material is chosen from diamond and sulfur.

48. The polymerizable composition of claim 40 wherein said nanoparticle material comprises a surface modifying chemical.

49. The polymerizable composition of claim 48, wherein said modifying chemical comprises a functionalizing agent and a hydrophobizing agent.

50. The polymerizable composition of claim 49, wherein said functionalizing agent has reactive groups chosen from vinyl, epoxy, glycidoxy, (meth)acryloxy, sulfide, polysulfide, mercapto, and mixtures thereof.

51. The polymerizable composition of claim 49, wherein said functionalizing agent is chosen from mercaptoorganometallic compounds, bis(alkoxysilylalkyl)polysulfides, and mixtures thereof.

52. The polymerizable composition of claim 49, wherein said hydrophobizing agent is chosen from non-sulfur organometallic compounds.

53. The polymerizable composition of claim 40 wherein said nanoparticle material is present in an amount of from 0.5 percent by weight to no greater than 50% by weight, of the polymerizable composition.

54. The polymerizable composition of claim 40 wherein said polymerizable monomer component is chosen from ethylenically unsaturated monomers, polyol(allyl carbonate) monomers, thiol monomers, polycyanate monomers, polycyanate prepolymers, polyepoxide prepolymers, and mixtures thereof.

55. The polymerizable composition of claim 54 wherein said ethylenically unsaturated monomer is an aromatic monomer having at least two vinyl groups.

56. The polymerizable composition of claim 54 wherein said thiol monomer is a polythiol monomer having at least two thiol groups.

57. The polymerizable composition of claim 54 wherein said polycyanate prepolymer has a number average molecular weight of from 500 to 15,000.

58. The polymerizable composition of claim 40 wherein said polymerizable monomer component comprises a reaction product of:
(a) a prepolymer comprising a polycyanate and at least one active hydrogen material; and
(b) an amine-containing curing agent.

59. The polymerizable composition of claim 58, wherein said active hydrogen material is chosen from polyols, polythiols, materials having both hydroxyl and thiol groups, and mixtures thereof.

60. The polymerizable composition of claim 59 wherein said polyol is chosen from polyether polyols, polyester polyols, polycaprolactone polyols, polycarbonate polyols, polyurethane polyols, and mixtures thereof

61. An at least partially cured polymerizate of the polymerizable composition of claim 40.

62. The at least partially cured polymerizate of claim 61 having an Abbe number of at least 25.

63. A photochromic article comprising the polymerizable composition of claim 40 and a photochromic amount of organic photochromic substance.

64. An optical article comprising a polymerizable composition which comprises nanoparticle material, said polymerizable composition when at least partially cured having a refractive index of from 1.595 to 1.695.
